(19) United States
(12) Patent Application Publication
(10) Pub. No.: US 2022/0303646 A1
(43) Pub. Date: Sep. 22, 2022

(54) DISPLACEMENT MEASUREMENT SYSTEMS AND METHODS WITH SIMULTANEOUS TRANSMISSION

(71) Applicant: VAYYAR IMAGING LTD., Yehud (IL)

(72) Inventors: Shay MOSHE, PETAH TIKVA (IL); Alexei KHAZAN, Rosh Haayin (IL); Iddo BAR DAVID, TEL AVIV (IL)

(21) Appl. No.: 17/619,636

(22) PCT Filed: Jun. 16, 2020
(86) PCT No.: PCT/IL2020/050665

§ 371 Date: Dec. 16, 2021

Related U.S. Application Data
(60) Provisional application No. 62/862,095, filed on Jun. 16, 2019.

(51) Int. Cl. H04Q 9/00

(52) U.S. Cl. CPC H04Q 9/00; H04Q 2209/40; H04Q 2209/845

(57) ABSTRACT

Systems and methods for identifying and/or measuring displacement of at least one sensor in system comprising at least two sensors, each sensor comprising a signal generator wherein the signal produced by the generator is used as a transmitted signal and as a local oscillator for down converting signals received from other sensors to produce an IF (intermediate frequency) signal; a data acquisition subsystem configured to generate data samples comprising phase information of the plurality of IF signals and record said data samples; at least one processor, said at least one processor is configured to: receive the recorded data samples from each sensor of said at least two sensors; jointly process the recorded data samples from each sensor of said at least two sensors to extract a phase value which depends on the distance between the at least two sensors; measure over time said phase value to yield a phase change value; identify displacement of at least one sensor of the at least two sensors based on the extracted phase change value.

### CROSS-REFERENCE

The present application claims the benefit of U.S. Provisional Application Ser. No. 62/862,095, filed on Jun. 16, 2019, entitled “SYSTEM AND METHOD FOR RADIO FREQUENCY PENETRATION IMAGING OF AN OBJECT” (attorney docket no. VY030/USP), the entire disclosures of which are incorporated herein by reference.

### TECHNICAL FIELD

The present invention, in some embodiments thereof, relates to displacement measurement systems and methods, and more specifically, but not exclusively, to RF (Radio Frequency) systems and methods for displacement measurement comprising simultaneous transmissions.

### INCORPORATION BY REFERENCE

All publications, patents, and patent applications mentioned in this specification are herein incorporated by reference to the same extent as if each individual publication, patent, or patent application was specifically and individually indicated to be incorporated by reference.

### BACKGROUND OF THE INVENTION

Measurements of small relative displacements of remote objects is a well-known need. An example of such need is monitoring of ground based structures to detect displacements induced by events such as earthquakes, landslides, etc. Undetected movement may result in danger to people and to structures, such as compromising structural integrity of a bridge or a road.

Optical methods using time-of-fight and interferometric measurements of distance to a retroreflector are well known, but these techniques depend on a clear line of sight and may fail in fog and rain.

RF-based techniques may serve this need with lesser dependence on a clear line of sight. An example of a technique for measuring displacements is described in US application number US20120235831 entitled “Position detection system and position detection sensor”, where a time of flight of radio waves is measured by establishing a precise time reference on both sides using an ultra-stable, e.g. rubidium, time reference oscillator. Such oscillators, however, are very costly, and eventually experience timing drift that needs to be measured and accounted for.

Radar-like technique can be used to measure roundtrip time of flight, as with optical methods. A retroreflector can be used to enhance the reflected power, e.g. a trihedral retroreflector. However, in the radiofrequency bands it is often more complicated to assure that the RCS of the retroreflector is substantially more than of other objects in its vicinity, so that the distance measurement accuracy is not hampered by other objects.

Other displacement measurement technique uses a reflector that manipulated the reflected signal. An example of such system is described in CN103792531A and in CN103308911A, where multiple reflectors are resolved by different manipulation of multiple reflectors.

### SUMMARY OF THE INVENTION

In accordance with a first embodiment of the present invention there is provided a system comprising: at least two sensors positioned at a distance from one another, wherein each sensor comprises: a generation and reception subsystem configured to: transmit and receive one or more RF (Radio Frequency) signals; down-convert said plurality of received RF signals to a plurality of IF (Intermediate Frequency) signals; an antenna subsystem, the antenna subsystem comprises one or more antennas, said one or more antennas are configured to: transmit the one or more RF signals towards each other sensor of the at least two sensors and receive a plurality of RF signals from the other at least two sensors a data acquisition subsystem configured and enabled to sample said plurality of IF signals and generate data samples comprising phase information of the plurality of IF signals and record said data samples; a time-base synchronization subsystem for acquiring and maintaining a common time-base between the two or more sensors and for enabling simultaneous transmission of the one or more RF signals by each sensor of the at least two sensors, and for enabling synchronization of signal sampling at each sensor of the at least two sensors; at least one processor, said at least one processor is configured to: receive the recorded data samples from each sensor of said at least two sensors; jointly process the recorded data samples from each sensor of said at least two sensors to extract a phase value which depends on the distance between the at least two sensors; measure over time said phase value to yield a phase change value; identify displacement of at least one sensor of the at least two sensors based on the extracted phase change value.

In an embodiment, the system comprising a first and second sensors, wherein the data samples of the first sensor is represented in the following first phasor representation:

Phasor_{A→B}=e^{j(-2πf}^{₀}^{τ}^{_{AB}}^{+φ}^{_{A}}^{-φ}^{_{B}}⁾

and the data samples of the second sensor is represented in the following second phasor representation:

Phasor_{B→A}=e^{j(-2πf}^{₀}^{τ}^{_{AB}}^{+φ}^{_{B}}^{-φ}^{_{A}}⁾

where f₀-transmitted frequency and φ_{A} and φ_{B}-arbitrary initial phases.

In an embodiment, the jointly process of said data samples comprises multiplying the first phasor with the second phasor.

In an embodiment, said multiplying the first and second phasors result is:

Phasor_{A→B}*Phasor_{B→A}=e^{j(-2πf}^{₀}^{*2τ}^{_{AB}}⁾

and the resulted phase value is:

$${Φ}_{AB} = 2 π {f}_{0} * 2 {τ}_{AB} = 2 π * \frac{{d}_{AB}}{λ / 2}$$

1 wherein the resulted phase value depends on the distance d_{AB} modulo λ/2 between the two sensors, and where

$$λ = \frac{c}{{f}_{0}}$$

is the transmitted signal wavelength and wherein the computed phase Φ_{AB} does not depend on the arbitrary transmission phases φ_{A} and φ_{B}.

In an embodiment, the distance change between the two sensors of δd is identified by calculating a phase change δϕ and wherein the phase change δϕ is:

$$δ ϕ = 2 π \frac{δ d}{λ / 2}$$

In an embodiment, the at least one processor is configured and enabled to cancel leakage of the one or more transmitted RF signals into the signal simultaneously received at the same sensor.

In an embodiment, the leakage is cancelled by transmitting and recording at each sensor of the at least two sensors a sequence of signals, and transmitting the recorded signals to the at least one processor which process the recorded signals to cancel the leakage.

In an embodiment, the time-base synchronization subsystem is selected from the group consisting of: GPS receivers, dedicated signalling exchange between sensors, wired common clock distribution.

In an embodiment, the at least one sensor of said at least two sensors comprises said at least one processor.

In an embodiment, the at least one processor is comprised in a central processor and wherein said central processor is external to said at least two processors.

In an embodiment, the antenna subsystem comprises one or more antenna arrays.

In accordance with a second embodiment of the present invention, there is provided a method for measuring the displacement of at least one sensor with respect to its initial position in a system comprising two or more sensors positioned at a distance from one another, the method comprising: simultaneously transmitting one or more RF signals from each sensor by one or more antennas at each sensor using a time-base synchronization subsystem; receiving at each sensor one or more antennas the signals transmitted by the other sensors; down-converting the received signals to IF (Intermediate Frequency) signals using a generation and reception subsystem; sampling the IF signals to generate data samples, said data samples comprising phase information of the IF signals; recording at each sensor data acquisition subsystem said data samples; transmitting said data samples of each sensor to at least one processor; jointly processing the data samples of each sensor of said at least two sensors based on signal processing algorithms to identify and measure the displacement of at least one sensor with respect to its initial position.

In an embodiment, the jointly processing of the recorded data samples from each sensor of said at least two sensors comprises: extracting a phase value which depends on the distance between the at least two sensors; measuring over time said phase value to yield a phase change value; and identifying the displacement of at least one sensor of the at least two sensors based on the extracted phase change value.

In an embodiment, the jointly process of said data samples comprises multiplying the first and second phasors.

In an embodiment, the at least one processor is configured to cancel leakage of the one or more transmitted RF signals into the signal simultaneously received at the same sensor.

In an embodiment, the leakage is cancelled by transmitting and recording at each sensor of the at least two sensors a sequence of signals, and transmitting the recorded signals to the at least one processor which process the recorded signals to cancel the leakage.

In an embodiment, the time-base synchronization subsystem is selected from the group consisting of: may include GPS receivers, dedicated signalling exchange between sensors, wired common clock distribution or other known methods or systems.

In an embodiment, the at least one sensor of sad at least two sensors comprises said at least one processor.

In an embodiment, the at least one processor is comprised in a central processor and wherein said central processor is external to said at least two processors.

In accordance with a third embodiment of the present invention there is provided a system comprising a plurality of sensors, each sensor comprising: a signal generator wherein the signal produced by the generator is used as a transmitted signal and as a local oscillator for down-converting signals received from other sensors to produce an IF (intermediate frequency) signal; a data acquisition subsystem configured to generate data samples comprising phase information of the plurality of IF signals and record said data samples; at least one processor, said at least one processor is configured to: receive the recorded data samples from each sensor of said at least two sensors; jointly process the recorded data samples from each sensor of said at least two sensors to extract a phase value which depends on the distance between the at least two sensors; measure over time said phase value to yield a phase change value; identify displacement of at least one sensor of the at least two sensors based on the extracted phase change value.

In an embodiment, the signal is selected from the group comprising: CW signal, stepped frequency signal, chirp signal.

### BRIEF DESCRIPTION OF THE DRAWINGS

A better understanding of the features and advantages of the present disclosure will be obtained by reference to the following detailed description that sets forth illustrative embodiments, in which the principles of embodiments of the present disclosure are utilized, and the accompanying drawings.

FIGS. 1 is a respective view of a system for identifying and measuring the displacement of one or more sensors such as sensors 110 and 120 with respect to the sensor's initial or previous position, in accordance with embodiments;

FIG. 2 is a block diagram illustrating the architecture of a sensor, in accordance with embodiments;

FIG. 3 shows a block diagram of a central processing unit which is in communication with two sensors, in accordance with embodiments;

FIG. 4A is a block diagram illustrating a transmitting unit of a first sensor and a receiving unit of a second sensor, in accordance with embodiments;

FIG. 4B shows a pair of sensors with simultaneous signal flow in both directions, in accordance with embodiments;

FIG. 5 illustrates a method for leakage measurement and cancellation in a system including two sensors A and B, each sensor comprising transmitter and receiver in accordance with embodiments;

FIG. 6 is a flowchart illustrating a method for measuring the displacement of at least one sensor with respect to its initial position in a system comprising two or more sensors in a scene, in accordance with embodiments; and

FIG. 7 is a flowchart illustrating the signal processing method for processing the recorded data samples) to identify and/or measure the displacement of one or more sensors in a scene, in accordance with embodiments.

### DETAILED DESCRIPTION OF THE INVENTION

In the following description, various aspects of the invention will be described. For the purposes of explanation, specific details are set forth in order to provide a thorough understanding of the invention. It will be apparent to one skilled in the art that there are other embodiments of the invention that differ in details without affecting the essential nature thereof. Therefore, the invention is not limited by that which is illustrated in the figure and described in the specification, but only as indicated in the accompanying claims, with the proper scope determined only by the broadest interpretation of said claims. The configurations disclosed herein can be combined in one or more of many ways to provide improved systems and methods for computing spatial displacement of points with respect to an original position. In a typical application, two or more sensors are mounted at fixed points on a structure and due to structural changes or distortions of one or more of the sensors may incur displacements with respect to their original position, resulting in a change of the distance between them. By measuring the change in distance, the sensors displacement can be computed. The system comprises two or more sensors such as RF sensors. The sensors are configured and enabled to transmit waveforms signals to each other, the received signals at two or more RF sensors are recorded and transmitted to one or more processors which use an algorithm for analyzing the recorded signals (e.g. recorded data) and compute the amount of displacement of the sensors with respect to an original position.

One or more components of the configurations disclosed herein can be combined with each other in many ways.

As used herein, like characters refer to like elements.

Prior to the detailed description of the invention being set forth, it may be helpful to set forth definitions of certain terms that will be used hereinafter.

As used herein, the term ‘displacement information’ encompasses a change in the locations of one or more objects (e.g. sensors) with respect to its initial or previous location.

In accordance with embodiments there are provided methods and systems for measuring roundtrip time of flight using at least two sensors transmitting signals to each other. The method is extendible to a network of sensors, where the displacement can be measured between multiple pairs of sensors using sequential or simultaneous transmissions.

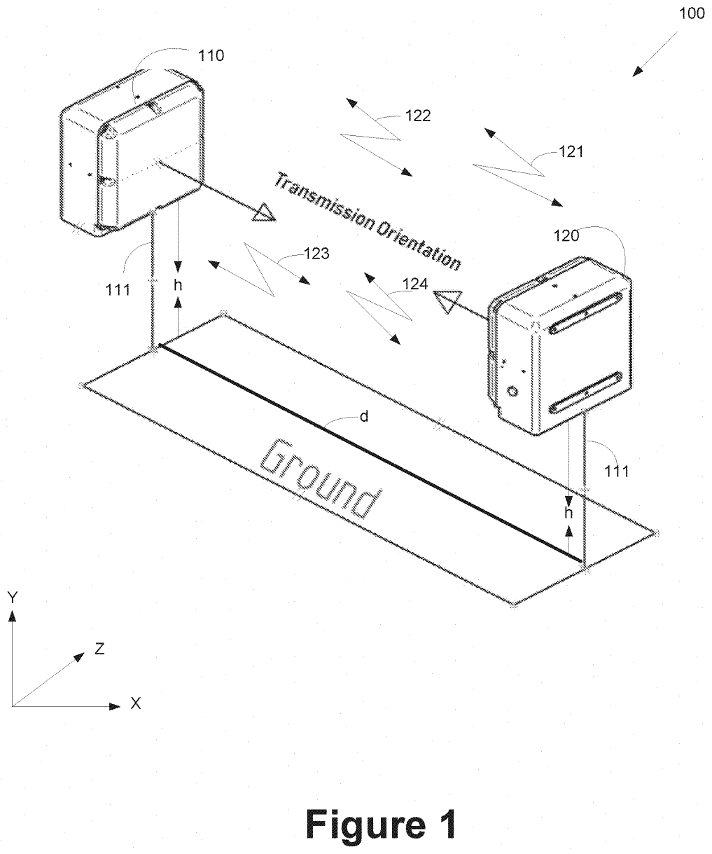

Referring now to the drawings, FIG. 1 is a respective view of a system 100 for measuring distance ‘d’ between the location of two or more sensors (e.g. transceivers), such as sensors 110 and 120 in a scene over time, and for identifying the displacement of one or more sensors such as sensors 110 and 120 with respect to the sensor's initial or previous position in an X-Y-Z Cartesian axes, in accordance with embodiments. Specifically, the system 100 is configured to measure a change in the distance ‘d’ between the sensors 110 and 120 by performing continuous measurements over time to detect displacement of the sensors 110 and 120 in respect to their initial position. The sensors ∠and 120 may be or may include RF antennas for transmitting and receiving RF signals, such as RF signals 121, 122, 123 and 124 transmitted along a transmission orientation (e.g. along X axis of the X-Y-Z Cartesian axes).

According to one embodiment, the sensors 110 and 120 may be mounted on the ground and are configured and enabled to transmit and receive signals (e.g. RF signals). The received signals at each sensor may be further transmitted to one or more processors such as a central processor which is configured to analyze the received signals from the two (or more) sensors based on one or more signal analysis algorithms to identify and/or measure the displacement of the sensors (e.g. sensor 110 and/or sensor 120) with respect to their initial position, for example due to movements of the ground. In another embodiment, the sensors 110 and 120 may be mounted on a structure such a shaft 111, seat or any device for holding the sensors, at a height ‘h’ for example on opposite sides in a scene such a building or bridge and are configured and enabled to transmit and receive signals, and further transmit the received signals to a central processor to evaluate a displacement incurred with respect to their initial position due to for example the distortion of the building, for example as a result of an earthquake.

The distance ‘d’ between the sensors is application dependent and can vary over a large range, from several meters, for example 1-10 meters up to a large distance, for example 100-1000 meters. Accordingly, the measured displacement with respect to their initial position may be starting of fraction of wavelength for example 1% of a wavelength to several wavelengths such as 10 wavelengths. For example for a 60 Ghz system may be 10, 20, or 50 more microns, to 50 or more mm

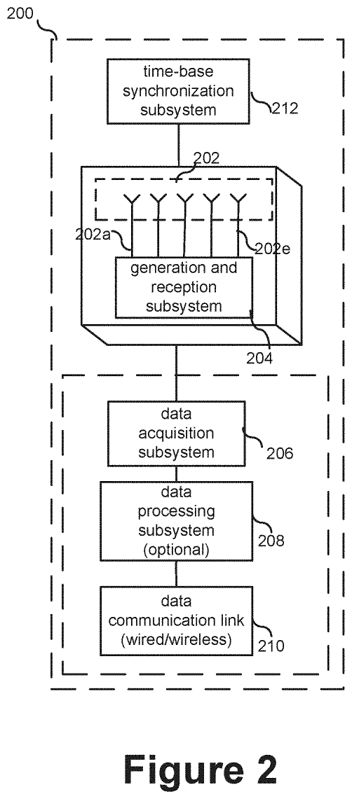

FIG. 2 is block diagram illustrating the architecture of a sensor 200, in accordance with embodiments. In some embodiments, sensors 110 and 120 of FIG. 1 may be sensor 200 or may include all or some of the units of sensor 200. The sensor 200 may include an RF signal generation and reception subsystem 204, an antenna subsystem 202, a data acquisition subsystem 206, a time-base synchronization sub-system 212, a data communication link subsystem 210, and optionally one or more data processors or processing subsystem 208.

The RF signal generation and reception subsystem 204 (e.g. transmit-receive or signal generator) is responsible for generation of the microwave signals (e.g. RF signals), coupling them to the antennas 202a-202e, reception of the microwave signals from the antennas. The RF signals can be stepped-frequency signals, chirp signals, pseudo-random noise sequences and the like. The generation circuitry can involve oscillators, synthesizers, NCOs (numerically Controlled Oscillators), AWGs (arbitrary Waveform Generators), mixers and filters. For example, the RF signals may be microwave signals in the 60 GHz or in 77 GHz bands.

In accordance with embodiments, the received signals are down-converted to an IF frequency at the signal generation and reception subsystem for further processing. The conversion process typically includes averaging in the form of low-pass filtering, to improve the signal-to-noise ratios and to allow for lower sampling rates. In an embodiment, the RF signal generation and reception subsystem 204 may comprise a single RF Integrated Circuit (RFIC) or several RFICs.

Sensor 200 (e.g. and sensors 110 and 120) may include one or more antennas such as antenna array 202. For example, the antenna array 202 may include multiple antennas 202a-202e typically between a few and several dozen (for example 30) antennas. The antennas can be of many types known in the art, such as printed antennas, waveguide antennas, dipole antennas or “Vivaldi” broadband antennas.

The data acquisition subsystem 206 collects and digitizes the IF signals from the RF signal generation and reception subsystem 204, and generating and recording the resulting data samples which comprise phase information of the plurality of IF signals for further processing. According to one embodiment, the data acquisition subsystem 206 includes synchronized sampling, analog-to-digital (A/D) converters and data storage. In other embodiments, the data acquisition subsystem 206 may include additional functions such as signal averaging, correlation of waveforms with templates or converting signals between frequency and time domain.

The time-base synchronization subsystem 212 is responsible for acquiring and maintaining a common time-base between two or more sensors, such as the sensors 110 and 120 thus enabling coordinated activities between the sensors, such as simultaneous transmission by the two (or more) sensors, signal sampling synchronized between the sensors and other coordinated activities. An example of time-base synchronization subsystem 212 or methods may be or may include GPS receivers, dedicated signaling exchange between sensors, wired common clock distribution or other known methods or systems.

The data processing subsystem 208 may include one or more processors and is responsible for processing, e.g. joint processing, the data samples received from all sensors such as sensors 110 and 120 (e.g. via a data communication link 210) based on one or more signal processing algorithms to yield displacement information related to the one or more sensors.

According to one embodiment, the data processing subsystem 208 may be included in one or more of the sensors such as sensors 110 and 120 (in addition to RF transmit-receive subsystem 204 and the antenna array subsystem 202). In this case, one of the sensors is designated as “central” and is configured to communicate via the data communication link 210 with the other sensors to receive and collect their recorded data samples for joint final processing.

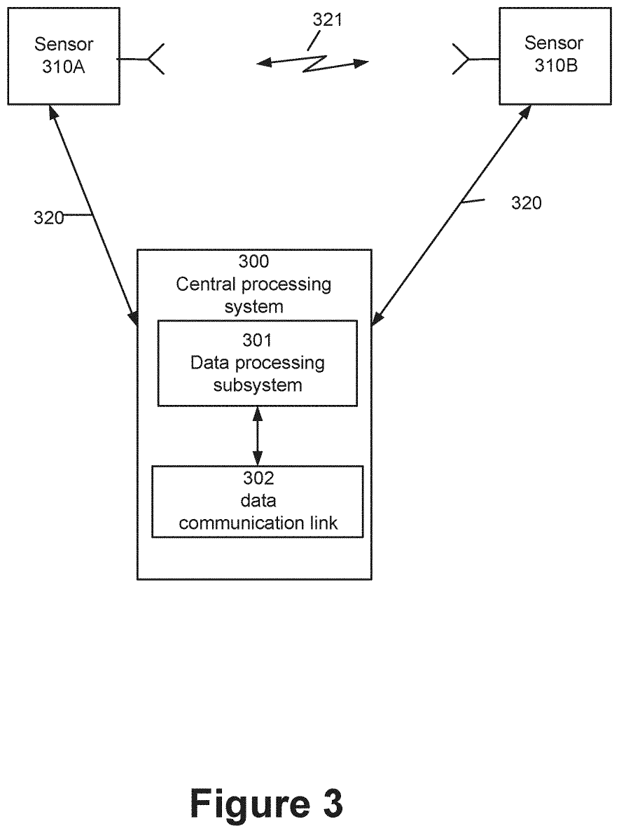

According to another embodiment, data processing functionality may be external to the sensors and is implemented by a central data processing unit external to the sensors, as shown for example in FIG. 3. The central processing unit 300 receives the recorded data samples from all sensors (e.g. 310a and 310b) via the transmissions links 320 and process, for example jointly process the recorded data samples using signal processing algorithms, in accordance with embodiments, to yield the displacement information.

The data communication link subsystem 210 is responsible for transmitting the acquired data samples to one or more processors, such as the data processing subsystem and/or the central data processing unit 300 for processing the acquired data samples of the one or more sensors (e.g. sensors 110 and 120 or sensor 310 and sensor 310b). The data communication subsystem may be wireless or wired and implemented in one or more ways known by the art methods and devices, such as WiFi, cellular, Ethernet, and the like.

FIG. 3 shows a block diagram of a central processing unit 300 which is in communication with two sensors, such as sensor 310A and sensor 310B, in accordance with embodiments. The two sensors are configured and enabled to simultaneity transmit and receive from one another RF signals such as RF signal 321 and generate data samples from the received RF signals comprising phase information of the plurality of RF signals and record said data samples. The central processing unit 300 may include a data communication link 302 (such as the data communication link subsystem 210 which is configured and enabled to receive the data samples and a data processing subsystem 301 which is configured and enabled to process the received recorded data samples using signal processing algorithms, in accordance with embodiments, to yield the displacement information.

In some embodiments, the central data processing unit 300 can be a handheld device or a server comprising cloud-based storage system using a communication circuitry with a communication link The communication link may be a wireless serial communication link, for example WiFi, Bluetooth™ and the like. In some cases, the handheld device can receive the data from the one or both sensors and transmit the data to a back end server of the cloud-based storage system.

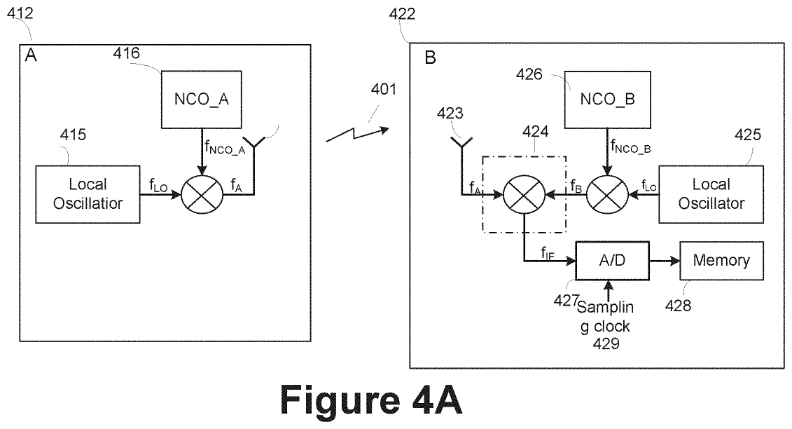

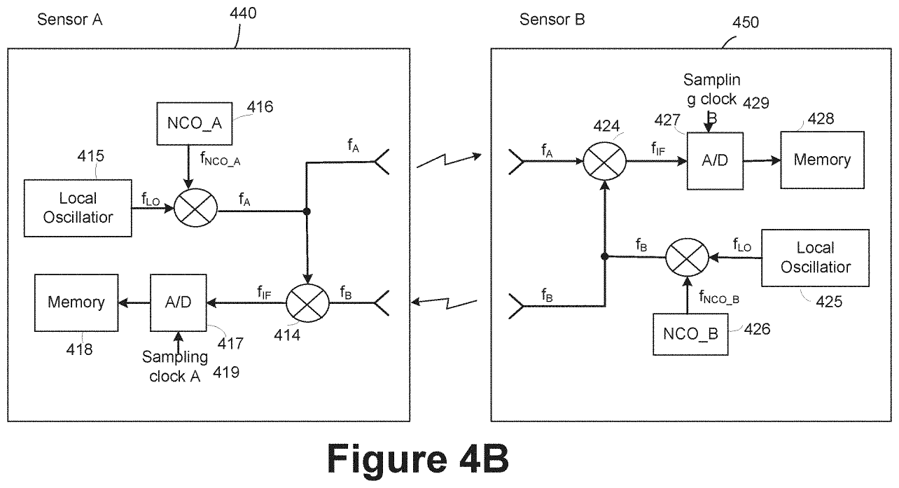

FIG. 4A is a block diagram illustrating a transmitting unit 412 of sensor 110 (denoted sensor A) and a receiving unit 422 of sensor 120 (denoted Sensor B), in accordance with embodiments. Specifically, FIG. 4A illustrates the signal flow of transmission of one or more signals 401 from an antenna 413 of transmission unit 412 to antenna 424 of receiving unit 422. The figure illustrates a typical way to generate at the transmitting unit 412 a transmitted signal 401 of frequency f_{A}, by mixing the output of local oscillator 415 of frequency f_{LO} with the output of a Numerically Controlled Oscillator NCO_{_A} 416 of frequency f_{NCO_A}, i.e. f_{A}=f_{LO}+f_{NCO_A}. Use of an NCO allows fine-grain control of the frequency, allowing, in particular, fine control of the resulting receive IF frequency.

At the receiving unit 422, the received signal of frequency f_{A} is down-converted by down-converter 424 to an intermediate frequency f_{IF} using a signal of frequency f_{B} as its local oscillator, i.e. f_{IB}=|f_{A}−f_{B}|.

The frequency f_{B} is generated by mixing the output of a local oscillator 425 of frequency f_{LO} with the output of NCO_{_B} 426 of frequency f_{NCO_B}, i.e. f_{B}=f_{LO}+f_{NCO_B}. Thus, by using f_{B} as the converting frequency of the down-converter 424, the IF frequency f_{IF} is f_{IF}=|f_{NCO_A}−f_{NCO_B}|, i.e the difference between the two NCOs (absolute value). Note that local oscillators 415 and 425 outputs are preferably at the same frequency f_{LO.}, but if for practical reasons (such as use of independent reference crystal oscillators) the oscillator frequencies differ slightly, this can be readily adjusted by the NCOs.

This IF signal is sampled by an Analog-to-Digital converter 427 by sample clock 429 and stored in a memory 428 for further processing by the central processing unit.

In accordance with embodiments, the sensors are identical, thus each has both a transmitting and a receiving unit.

FIG. 4B shows the signal flow in both directions, in accordance with embodiments. Specifically, FIG. 4B shows the transmission of a signal from the transmit-receive unit 440 of sensor 110 (sensor A) and received by the transmit-receive unit 450 of sensor 120 (sensor B) and the simultaneous transmission from transmit-receive unit 450 of sensor 120 (sensor B) and received by the transmit-receive unit 440 of sensor 110 (sensor A).

The generation of the transmitted signal of the transmit-receive unit 440 (sensor A) at frequency f_{A}=f_{LO}+f_{NCO_A}, by mixing local oscillator 415 output with NCO_A 416 output is shown. The frequency f_{A} is used as the down-converting frequency (local oscillator) for the received signal of frequency f_{B} transmitted from 450 (sensor B) and producing an IF signal of frequency f_{IF}=|F_{A}−f_{B}|. The down-conversion is done by down-converter 414. The IF signal is sampled at the A/D converter 417 using sampling clock 419 and stored at memory 418 for further processing.

In a similar way, the signal transmitted by 450 (sensor B) is generated at a frequency f_{B}=f_{LO}+f_{NCO_B}, by mixing local oscillator 425 output with NCO_B 426 output The frequency f_{B} is used as the down-converting frequency (local oscillator) for the received signal of frequency f_{A} transmitted from 440 (sensor A) and producing an IF signal of frequency F_{IF}=|F_{A}−f_{B}|. The down-conversion is done by down-converter 424. The IF signal is sampled at the A/D converter 427 using sampling clock 429 and stored at memory 428 for further processing.

The local oscillators 415 and 425 preferably have an identical output frequency f_{LO}. Also, the sampling clocks 419 and 429 have same sampling frequency and the sampling is synchronized between them.

In accordance with embodiments, there are provided a method and system to detect and compute one or more sensors displacement with respect to their initial position, while canceling arbitrary phases of the signal transmitted by the one or more sensors. The system includes at least two sensors, denoted here A and B. Each sensor (A and B) transmits a signal which may be received by the other sensor. In accordance with embodiments, prior to the measurement and displacement identification the sensors are time-synchronized, i.e. have a common time base, thus enabling coordination between the sensors and accordingly simultaneously transmitting signal one to the other.

It is stressed that, for simplicity matters, transmission of CW signals is assumed. Also, as illustrated herein below, the derivation depends on signal phases thus the amplitude component of the signals may be ignored. The derivation is as follows:

At an initial time t=0, sensor A transmits a CW signal according to the following Eq (1):

x_{A}(t)=sin(2πf₀t+φ_{A}), (1)

where f₀-transmitted frequency and φ_{A}-arbitrary phase at t=0.

The signal is received at sensor B at time τ_{AB} as illustrated in Eq (2):

y_{B}(t)=x_{A(t-τ}_{_{AB}}₎==sin [2πf₀(t−τ_{AB})+φ_{A}],

where τ_{AB}-signal propagation time from sensor A to sensor B,

The received signal is down-converted at sensor B to an IF frequency f_{IF}, resulting in a signal according to Eq (3):

z_{B}(t)=sin(2πf_{IF}t−2πf₀τ_{AB}+φ_{A}−φ_{B}) (3)

where φ_{B}-arbitrary phase at t=0 of the B local oscillator.

The information of interest is in the phase of the signal, i.e. (−2πf₀τ_{AB}+φ_{A}−φ_{B}).

For convenience matters the signal phase of interest is presented using phasor (complex) representation by Eq (4):

Phasor_{A→B}=e^{j(-2πf}^{₀}^{τ}^{_{AB}}^{+φ}^{_{A}}^{-φ}^{_{B}}⁾ (4)

The information represented by this phasor is sampled, stored, and sent for example to a central location comprising one or more processors at one of the sensors or external to the processors.

Simultaneity, at the same time t=0, sensor B transmits (simultaneously with sensor A transmission) a CW signal which is received by sensor A. With exactly the same math, the phase of interest resulting from the transmission from sensor B to sensor A in phasor representation is according to Eq (5):

Phasor_{B→A}=e^{j(-2πf}^{₀}^{τ}^{_{AB}}^{+φ}^{_{B}}^{-φ}^{_{A}}⁾ (5)

The information represented by this phasor is sampled, stored and sent (via a dedicated data link) to a central location, for joint processing. The central location can be for example the central data processing unit (e.g. data processing subsystem 208 or central processing unit 300). p The algorithm performed by the processor, at the central location, comprises multiplying the two phasors and extract the resulting phase. The resulting phasor is according to Eq (6):

Phasor_{A→B}*Phasor_{B→A}=e^{j(-2πf}^{₀}^{*2τ}^{_{AB}}⁾ (6)

Thus, its phase is:

$${Φ}_{AB} = 2 π {f}_{0} * 2 {τ}_{AB} = 2 π * \frac{{d}_{AB}}{λ / 2} \qquad ( 7 )$$

which depends(e.g. only) on the distance d_{AB} modulo λ/2 between the sensors, and where

$$λ = \frac{c}{{f}_{0}}$$

is the transmitted signal wavelength. The computed phase Φ_{AB} does not depend on the arbitrary transmission phases φ_{A} and φ_{B}, i.e. cancellation of the arbitrary phases is achieved via this method.

If at a later time, a displacement value δd (e.g. a phase change value) of the sensors occurs, a new transmission of signals from A to B and from B to A would result in a phase change of displacement value δϕ:

$$δ ϕ = 2 π \frac{δ d}{λ / 2} \qquad ( 8 )$$

In accordance with embodiments, as long as the displacement value δd is smaller than half wavelength, the displacement can be evaluated from this phase. The range of displacement measurement can be increased by using transmissions at multiple frequencies, for example, either chirp or stepped CW signals. Simultaneous transmission and receiving (at the same frequency) result in high leakage of the transmitted signal into the received signal.

In accordance with some embodiments, the system and methods may optionally include canceling a leakage of the transmitted signal into its own receiver (e.g. the resulted high leakage), by transmitting and recording at each sensor (e.g. sensor 310A and sensor 310B) a sequence of signals in a coordinated way, and processing the recorded signal to cancel the leakage. This processing can be performed by each sensor separately or by sending the signals to the central processing unit.

It is stressed that for sake of derivation simplicity, the derivation above (equations 1-8) has ignored this leakage.

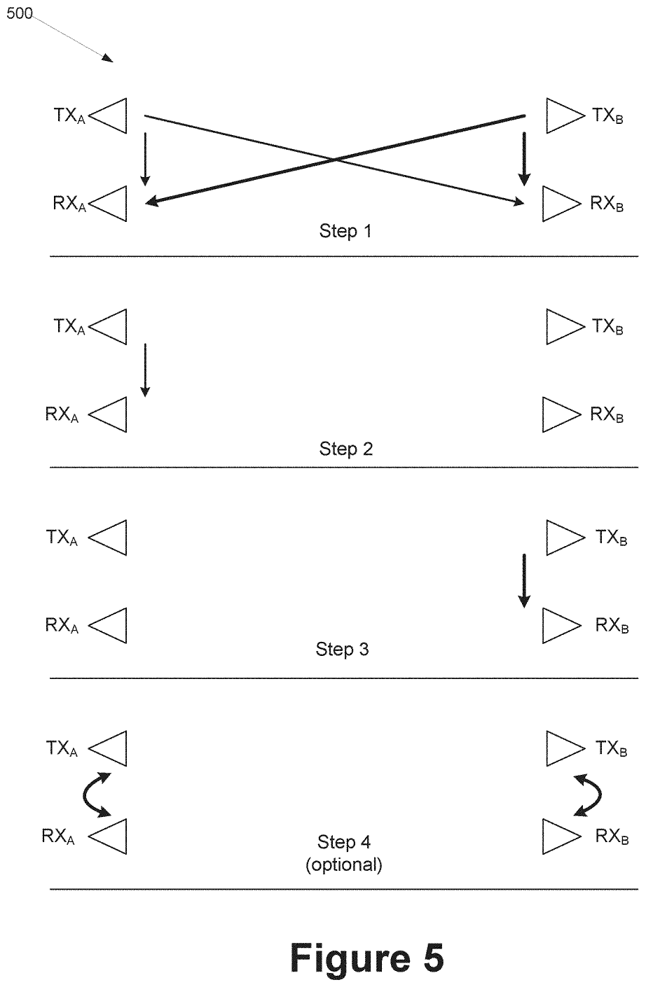

FIG. 5 illustrates a method 500 for leakage measurement and cancellation in a system including two sensors A and B, each sensor comprising transmitter and receiver in accordance with embodiments, a sequence of three measurement steps is performed by the sensors in a coordinated way, followed by a cancellation computation. At measurement step 1, signals are transmitted simultaneously form each sensor to the other sensor: receiver of sensor A receives the transmitted signal TX_{B} of sensor B corrupted by its own transmission (i.e. leakage) TX_{A} and in a similar way, the receiver B receives the signal TX_{A} from sensor A, corrupted by its own transmission TX_{B}. Thus, each sensor records the appropriate phasor (similar to equation 4 and 5) but this time corrupted by the leakage.

Step 1: The leakage corrupted signal recorded by sensor A at time t=0 is denoted (TX_{A}.TX_{B}→RX_{A}) and the leakage corrupted signal recorded simultaneously by sensor B is denoted (TX_{B}.TX_{A}→RX_{B}).

Step 2: At a subsequent instance, e.g. t=1 only sensor A transmits and receives its own leakage signal denoted (TX_{A}→RX_{A}) which is also appropriately recorded. No transmission from B.

Step 3: At a subsequent instance, e.g. t=2, only sensor B transmits and receives its own leakage signal denoted (TX_{B}→RX_{B}) which is also appropriately recorded. No transmission from A.

Following the three measurement steps, the leakage of each sensor is cancelled as follows: For Sensor A: A quantity related to its leakage only signal (TX_{A}→RX_{A}) (of step 1) is subtracted from a quantity related to the received leakage corrupted signal (TX_{A}.TX_{B}→RX_{A}) (of step 2) resulting in a leakage free received signal from sensor B (TX_{B}→RX_{A})

(TX_{A}.TX_{B}→RX_{A})−(TX_{A}→RX_{A})=(TX_{B}→RX_{A}) for sensor A (10)

For Sensor B: A quantity related to its leakage only signal (TX_{A}→RX_{B}) (of step 1) is subtracted from a quantity related to the received leakage corrupted signal (TX_{B}.TX_{A}→RX_{B}) (of step 3) resulting in a leakage free received signal from sensor A (TX_{A}→RX_{B})

(TX_{B}.TX_{A}→RX_{B})−(TX_{B}→RX_{B})=(TX_{A}→RX_{B}) for unit B (11)

In accordance with embodiments, the cancellation can be performed at each sensor by itself or deferred to the central processing unit by sending both the leakage corrupted signal and the leakage only signal for each sensor.

An optional step (step 4) can be performed at t=3 with both sensors performing an internal loopback. The optional signals recorded in t=3 can be used to address in-chip signal leakage or to correct signal distortions.

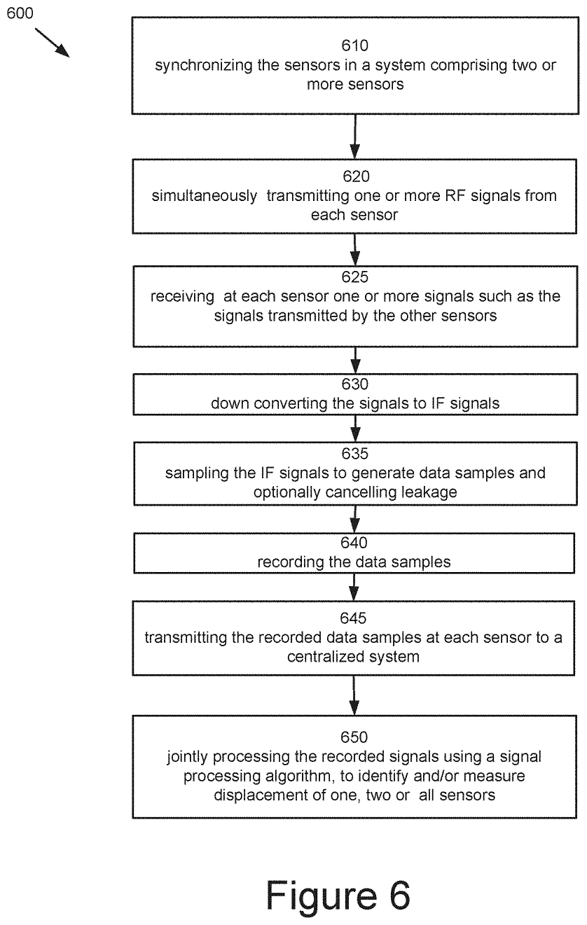

FIG. 6 is a flowchart illustrating a method 600 for measuring the displacement of at least one sensor with respect to its initial position in a system comprising two or more sensors in a scene, in accordance with embodiments. Step 610 comprises time synchronizing the sensors. Time synchronization between the different sensors is mandatory in order to synchronize the TX and RX recording windows, e.g. that all sensors (e.g. sensor 110 and sensor 120 of FIG. 1 or sensor 310A and sensor 310B of FIG. 3) perform their signal transmission, receiving, data sampling in a synchronized way. The synchronizing step may include transmitting one or more signals such as RF signals from one sensor to the other, so all sensors will run simultaneously (e.g. transmit at the same time). In some embodiments, the synchronization step is performed using one or more of: wired trigger, wireless trigger or a highly accurate global clock (e.g. GPS clock). According to some embodiments, the synchronization is performed by the time-base synchronization subsystem 212.

Step 620 comprises simultaneously transmitting one or more RF signals from each sensor, for example by one or more antennas of the antenna system 202 and step 625 comprises receiving at each sensor, i.e. at the antenna system of each sensor, one or more signals such as the signals transmitted by the other sensors and recording the one or more received signals. In accordance with embodiments, the transmission instances are synchronized across all sensors, e.g. two sensors initiate simultaneous transmission one to the other (transmit at the same time).

Step 630 comprises down-conversion of the received signals to IF (Intermediate Frequency) signals using for example the generation and reception subsystem 204, in accordance with embodiments.

Step 635 comprises sampling and recording the IF signals generating data samples for further processing. In some cases, sampling and recording are performed by the data acquisition subsystem 206. In accordance with embodiments, the sensors (e.g. all sensors) sample the signals using a common same time-base, e.g. synchronized sampling across all sensors.

### Leakage Effect Measurement and Cancellation

During the process of simultaneous transmission and receiving, the received signals at each sensor may incur high interference from its own transmission, i.e. high leakage. In accordance with embodiments, there are provided procedures to cancel the effect of this leakage by a coordinated sequence of transmissions and receptions from the sensors (e.g. all sensors) to enable each sensor to detect its own leakage and record it as part of the recorded data for further processing. Specific examples of the coordinated sequence of transmissions and receptions are illustrated with respect to the above mentioned measurement steps 1, 2 and 3 of FIG. 5 and related detailed explanations.

In accordance with some embodiments, step 635 may further comprise cancelling the leakage effect. For example, each sensor performs the sequence of transmissions to generate the intermediate measurements of step 1, 2 and 3 (e.g. FIG. 5 and related explanations). The leakage effect is cancelled according to equation 10 and equation 11 (optionally).

In another embodiment, leakage cancellation is deferred and performed at a central processor (e.g. central processing subsystem), thus the intermediate measurements of previous steps 610, 620, 625 and 630 are only recorded and later sent to the central processor for further leakage cancellation according to equation 10 and equation 11.

Step 640 comprises recording the data samples, for example as each sensor data acquisition subsystem 206, in accordance with embodiments.

Step 645 comprises, in accordance with embodiments, transmitting the data samples (e.g. IF signal data samples which are the recorded data samples at each sensor) to a one or more processors such as processors 301 located at central processing subsystem 300 which is configured to identify and/or measure the displacement of the sensors with respect to an initial position, based on the recorded signal data samples.

Alternatively or in combination, the recorded data samples may be transmitted to one of the sensors which include one or more processors (e.g. data processing subsystem 208) to identify and/or measure the displacement of the sensors based on the recorded signal data samples.

Step 650 comprising processing the received signals (e.g. recorded data samples) of all sensors (e.g. sensors 110 and 120) using signal processing methods, such as a signal processing method 700 to identify and/or measure the displacement of one, two or all sensors, in accordance with embodiments.

Specifically, step 650 comprises jointly processing the recorded data samples from each sensor to extract a phase value which depends on the distance between the at least two sensors; measuring over time the phase value to yield a phase change value; and identifying displacement of at least one sensor of the at least two sensors based on the extracted phase change value.

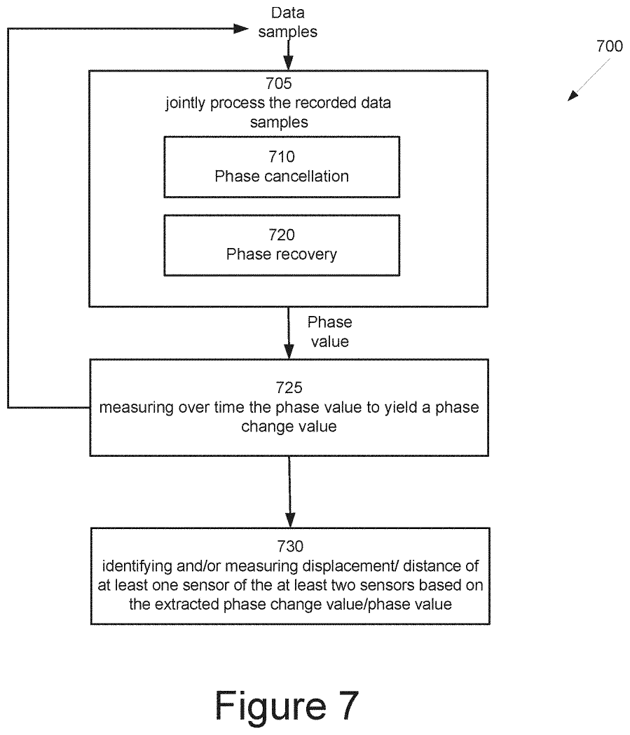

FIG. 7 is a flowchart illustrating the signal processing method 700 for processing the recorded data samples (e.g. received signals of two or more sensors) to identify and/or measure the displacement of one or more sensors in a scene, in accordance with embodiments. The method 700 may be performed externally by a processor at the central location and/or internally at one of the two or more processors of the “central” sensor in order to detect and measure the displacement.

Step 705 comprises jointly process the recorded data samples from each sensor of said at least two sensors to extract a phase value which depends on the distance between the at least two sensors.

Specifically, step 705 comprises two steps phase cancellation (step 710) and phase recovery (step 720).

Phase cancellation (step 710): phase cancellation comprises canceling the impact of the arbitrary initial phases of the sensors local oscillators. This is performed for example by multiplying the recorded data samples, received from the sensors, e.g. the two simultaneous transmissions—A to B and B to A, in a phasor representation, as was illustrated hereinabove with respect to equation (6). The output of step 710 includes a signal (for example in a phasor representation) where the phase depends on distance/displacement.

Phase recovery (step 720): Following the cancellation process of the arbitrary initial phases, the resulting signal has a phase proportional to the distance/displacement of the sensors. Specifically, step 720 comprises processing the signal to yield a phase value.

Step 725 comprises measuring over time the phase value to yield a phase change value. Specifically, step 725 comprises repeating the calculations of step 705 based on ongoing received data samples

Step 730 comprises identifying and/or measuring displacement of at least one sensor of the at least two sensors based on the extracted phase change value. In some cases, step 730 may further include measuring the distance between the sensors based on the measured phase values. In accordance with embodiments, the distance/displacement is calculated while taking care of the potential ambiguity of the displacement due to phase wraparound of the signal, as per equation 7 and equation 8.

In one embodiment, method 700 comprises dividing the distance/displacement range and further using a frequency step which is twice the maximal required measurement range to avoid ambiguity.

Alternatively or in combination, method 700 may comprise calculating the square root of all phasors to derive the original phase. In some embodiments, a dynamic programming approach can be used to resolve the ambiguity. A solution is found starting from an initial coarse value of a range of distance/displacement and assuming that for a sufficiently small frequency step the measured phase over frequency is continuous.

### Multi-Path Rejection

The nature of the methods and systems in accordance with embodiments is such that multi-paths of the signals are very close temporally to the line of sight signal. This can result in difficulties with measuring an accurate displacement of the sensors. Multiple methods can be used to decrease multi-path effect.

### Receiver Diversity

In some embodiments, instead of using a single antenna, each sensor may comprise an array of antennas to be used as receivers to improve the resistance to the multi-path signal. Each antenna has a slightly different line of sight and different multi-paths. System and methods in accordance with embodiments comprise using data (e.g. receiving and transmitting signals) from multiple antennas to perform a measurement weighted by the quality of the signal and the amount of multi-path interference, hence the more antenna used the better our performance will be, typically 3-10 antennas.

### Directionality and Beam-Steering

Alternatively or in combination, multi-path rejection systems and methods in accordance with embodiments include narrowing the Tx and/or Rx beam. The narrower the beam, the less interference we'll get from the multi-paths. Narrow beam and beam steering are easily implemented by each sensor comprising an antenna array.

### Polarization:

Alternatively or in combination, for multi-path rejection systems and methods in accordance with embodiments, antenna polarization can be used to reduce multi-path signal intensity as well. Specifically, by using linear polarization the reflected signals may be minimized to surfaces which are roughly parallel to antenna polarization. Therefore, an orientation can be found which provides better performance Another variant of the linear polarization solution may include using multiple antennas with two different linear polarizations (perpendicular to each other). By measuring both polarities we can the line of sight signal may be single out (which has an identical response unlike the multi-path).

### Alternate Waveforms

In accordance with embodiments, various types of waveform generators may used for generating the location information. In some embodiments, a wideband stepped CW signal can be used to measure the phase per frequency and derive the distance (by Fourier transform of the wideband information) and displacement (by phase measurement as described). Other options include a chirp signal which enables displacement measurements by IF calculation or PRBS signals over the frequency range.

### Multi-Sensor Networks

Network of multiple sensors may be used to measure displacement over multiple pairs of sensors, to allow, for example, two-dimensional displacement measurement, e.g. longitude and width displacement with respect the sensors' initial or previous location. The displacement measurement between different pairs can be performed sequentially. Alternately, the sensors can transmit at different frequencies, and receive the signals of other sensors simultaneously. By having different intermediate frequencies (e.g. |f_{B}−f_{A}| and |f_{C}−f_{A}|) the signals can be separated by Fourier techniques and their phases measured independently. For larger groups of sensors, U.S. application Ser. No. 16/704,009, incorporated herein by reference, describes a method of selecting groups of transmit frequencies so that in each receiver the absolute values of the differences between the frequencies differ. For example, for four sensors transmit frequencies f_{A}, f_{B}=f_{A}+df, f_{C}=f_{A}+3*df, f_{D}=f_{A}+4*dF can be used to ensure this property.

In further embodiments, the processing unit may be a digital processing device including one or more hardware central processing units (CPU) that carry out the device's functions. In still further embodiments, the digital processing device further comprises an operating system configured to perform executable instructions. In some embodiments, the digital processing device is optionally connected to a computer network. In further embodiments, the digital processing device is optionally connected to the Internet such that it accesses the World Wide Web. In still further embodiments, the digital processing device is optionally connected to a cloud computing infrastructure. In other embodiments, the digital processing device is optionally connected to an intranet. In other embodiments, the digital processing device is optionally connected to a data storage device.

In accordance with the description herein, suitable digital processing devices include, by way of non-limiting examples, server computers, desktop computers, laptop computers, notebook computers, sub-notebook computers, netbook computers, netpad computers, set-top computers, handheld computers, Internet appliances, mobile smartphones, tablet computers, personal digital assistants, video game consoles, and vehicles. Those of skill in the art will recognize that many smartphones are suitable for use in the system described herein. Those of skill in the art will also recognize that select televisions with optional computer network connectivity are suitable for use in the system described herein. Suitable tablet computers include those with booklet, slate, and convertible configurations, known to those of skill in the art.

In some embodiments, the digital processing device includes an operating system configured to perform executable instructions. The operating system is, for example, software, including programs and data, which manages the device's hardware and provides services for execution of applications.

In some embodiments, the device includes a storage and/or memory device. The storage and/or memory device is one or more physical apparatuses used to store data or programs on a temporary or permanent basis. In some embodiments, the device is volatile memory and requires power to maintain stored information. In some embodiments, the device is non-volatile memory and retains stored information when the digital processing device is not powered.

In some embodiments, the system disclosed herein includes software, server, and/or database modules, or use of the same. In view of the disclosure provided herein, software modules are created by techniques known to those of skill in the art using machines, software, and languages known to the art. The software modules disclosed herein are implemented in a multitude of ways. In various embodiments, a software module comprises a file, a section of code, a programming object, a programming structure, or combinations thereof. In further various embodiments, a software module comprises a plurality of files, a plurality of sections of code, a plurality of programming objects, a plurality of programming structures, or combinations thereof. In various embodiments, the one or more software modules comprise, by way of non-limiting examples, a web application, a mobile application, and a standalone application. In some embodiments, software modules are in one computer program or application. In other embodiments, software modules are in more than one computer program or application. In some embodiments, software modules are hosted on one machine. In other embodiments, software modules are hosted on more than one machine. In further embodiments, software modules are hosted on cloud computing platforms. In some embodiments, software modules are hosted on one or more machines in one location. In other embodiments, software modules are hosted on one or more machines in more than one location.

In some embodiments, the system disclosed herein includes one or more databases, or use of the same. In view of the disclosure provided herein, those of skill in the art will recognize that many databases are suitable for storage and retrieval of information as described herein.

In the above description, an embodiment is an example or implementation of the inventions. The various appearances of “one embodiment,” “an embodiment” or “some embodiments” do not necessarily all refer to the same embodiments.

Although various features of the invention may be described in the context of a single embodiment, the features may also be provided separately or in any suitable combination. Conversely, although the invention may be described herein in the context of separate embodiments for clarity, the invention may also be implemented in a single embodiment.

Reference in the specification to “some embodiments”, “an embodiment”, “one embodiment” or “other embodiments” means that a particular feature, structure, or characteristic described in connection with the embodiments is included in at least some embodiments, but not necessarily all embodiments, of the inventions.

It is to be understood that the phraseology and terminology employed herein is not to be construed as limiting and are for descriptive purpose only.

The principles and uses of the teachings of the present invention may be better understood with reference to the accompanying description, figures and examples.

It is to be understood that the details set forth herein do not construe a limitation to an application of the invention.

Furthermore, it is to be understood that the invention can be carried out or practiced in various ways and that the invention can be implemented in embodiments other than the ones outlined in the description above.

It is to be understood that the terms “including”, “comprising”, “consisting” and grammatical variants thereof do not preclude the addition of one or more components, features, steps, or integers or groups thereof and that the terms are to be construed as specifying components, features, steps or integers.

If the specification or claims refer to “an additional” element, that does not preclude there being more than one of the additional element.

It is to be understood that where the claims or specification refer to “a” or “an” element, such reference is not be construed that there is only one of that element. It is to be understood that where the specification states that a component, feature, structure, or characteristic “may”, “might”, “can” or “could” be included, that particular component, feature, structure, or characteristic is not required to be included. Where applicable, although state diagrams, flow diagrams or both may be used to describe embodiments, the invention is not limited to those diagrams or to the corresponding descriptions. For example, flow need not move through each illustrated box or state, or in exactly the same order as illustrated and described. Methods of the present invention may be implemented by performing or completing manually, automatically, or a combination thereof, selected steps or tasks.

The descriptions, examples, methods and materials presented in the claims and the specification are not to be construed as limiting but rather as illustrative only. Meanings of technical and scientific terms used herein are to be commonly understood as by one of ordinary skill in the art to which the invention belongs, unless otherwise defined. The present invention may be implemented in the testing or practice with methods and materials equivalent or similar to those described herein.

While the invention has been described with respect to a limited number of embodiments, these should not be construed as limitations on the scope of the invention, but rather as exemplifications of some of the preferred embodiments. Other possible variations, modifications, and applications are also within the scope of the invention. Accordingly, the scope of the invention should not be limited by what has thus far been described, but by the appended claims and their legal equivalents.

All publications, patents and patent applications mentioned in this specification are herein incorporated in their entirety by reference into the specification, to the same extent as if each individual publication, patent or patent application was specifically and individually indicated to be incorporated herein by reference. In addition, citation or identification of any reference in this application shall not be construed as an admission that such reference is available as prior art to the present invention. To the extent that section headings are used, they should not be construed as necessarily limiting.

What is claimed is:

1. A system comprising:
at least two sensors positioned at a distance from one another, wherein each sensor comprises:
a generation and reception subsystem configured to:
transmit and receive one or more RF (Radio Frequency) signals;
down-convert said plurality of received RF signals to a plurality of IF (Intermediate Frequency) signals;
an antenna subsystem, the antenna subsystem comprises one or more antennas, said one or more antennas are configured to:
transmit the one or more RF signals towards each other sensor of the at least two sensors and receive a plurality of RF signals from the other at least two sensors;
a data acquisition subsystem configured and enabled to sample said plurality of IF signals and generate data samples comprising phase information of the plurality of IF signals and record said data samples;
a time-base synchronization subsystem for acquiring and maintaining a common time-base between the two or more sensors and for enabling simultaneous transmission of the one or more RF signals by each sensor of the at least two sensors, and for enabling synchronization of signal sampling at each sensor of the at least two sensors;
at least one processor, said at least one processor is configured to:
receive the recorded data samples from each sensor of said at least two sensors;
jointly process the recorded data samples from each sensor of said at least two sensors to extract a phase value which depends on the distance between the at least two sensors;
measure over time said phase value to yield a phase change value;
identify displacement of at least one sensor of the at least two sensors based on the extracted phase change value.

2. The system of claim 1, comprising a first sensor and a second sensor, wherein the data samples of the first sensor is represented in the following first phasor representation:
Phasor_{A→B}=e^{j(-2πf}^{₀}^{τ}^{_{AB}}^{+φ}^{_{A}}^{-φ}^{_{B}}⁾
and the data samples of the second sensor is represented in the following second phasor representation:
Phasor_{B→A}=e^{j(-2πf}^{₀}^{τ}^{_{AB}}^{+φ}^{_{B}}^{-φ}^{_{A}}⁾
where f₀-transmitted frequency and φ_{A} and φ_{B}-arbitrary initial phases.

3. The system of claim 2, wherein said jointly process said data samples comprises multiplying the first phasor with the second phasor.

4. The system of claim 3, wherein said multiplying the first and second phasors result is:
Phasor_{A→B}*Phasor_{B→A}=e^{j(-2πf}^{₀}^{*2τ}^{_{AB}}⁾
and the resulted phase value is:
$${Φ}_{AB} = 2 π {f}_{0} * 2 {τ}_{AB} = 2 π * \frac{{d}_{AB}}{λ / 2}$$
wherein the resulted phase value depends on the distance d_{AB} modulo λ/2 between the two sensors, and where
$$λ = \frac{c}{{f}_{0}}$$
is me transmitted signal wavelength and wherein the computed phase Φ_{AB} does not depend on the arbitrary transmission phases φ_{A} and φ_{B}.

5. The system of claim 2, wherein a distance change between the two sensors of δd is identified by calculating a phase change δϕ and wherein the phase change δϕ is:
$$δ ϕ = 2 π \frac{δ d}{λ / 2}$$

6. The system of claim 1 wherein the at least one processor is configured and enabled to cancel leakage of the one or more transmitted RF signals into the signal simultaneously received at the same sensor.

7. The system of claim 6, where the leakage is cancelled by transmitting and recording at each sensor of the at least two sensors a sequence of signals, and transmitting the recorded signals to the at least one processor which processes the recorded signals to cancel the leakage.

8. The system of claim 1, wherein the time-base synchronization subsystem is selected from the group consisting of: GPS receivers, dedicated signaling exchange between sensors, wired common clock distribution.

9. The system of claim 1, wherein at least one sensor of said at least two sensors comprises said at least one processor.

10. The system of claim 1, wherein said at least one processor is comprised in a central processor and wherein said central processor is external to said at least two processors.

11. The system of claim 1, wherein the antenna subsystem comprises one or more antenna arrays.

12. A method for measuring the displacement of at least one sensor with respect to its initial position in a system comprising two or more sensors positioned at a distance from one another, the method comprising:
simultaneously transmitting one or more RF signals from each sensor by one or more antennas at each sensor using a time-base synchronization subsystem;
receiving at each sensor one or more antennas the signals transmitted by the other sensors;
down-converting the received signals to IF (Intermediate Frequency) signals using a generation and reception subsystem;
sampling the IF signals to generate data samples, said data samples comprising phase information of the IF signals;
recording at each sensor data acquisition subsystem said data samples;
transmitting said data samples of each sensor to at least one processor;
jointly processing the data samples of each sensor of said at least two sensors based on signal processing algorithms to identify and measure the displacement of at least one sensor with respect to its initial position.

13. The method of claim 12, wherein jointly processing the recorded data samples from each sensor of said at least two sensors comprises:
extracting a phase value which depends on the distance between the at least two sensors;
measuring over time said phase value to yield a phase change value; and
identifying the displacement of at least one sensor of the at least two sensors based on the extracted phase change value.

14. The method of claim 12, comprising a first sensor and a second sensor, wherein the data samples of the first sensor is represented in the following first phasor representation:
Phasor_{A→B}=e^{j(-2πf}^{₀}^{τ}^{_{AB}}^{+φ}^{_{A}}^{-φ}^{_{B}}⁾
and the data samples of the second sensor is represented in the following second phasor representation:
Phasor_{B→A}=e^{j(-2πf}^{₀}^{τ}^{_{AB}}^{+φ}^{_{B}}^{-φ}^{_{A}}⁾
where f₀-transmitted frequency and φ_{A} and φ_{B}-arbitrary initial phases.

15. The method of claim 12, wherein said jointly process said data samples comprises multiplying the first and second phasors.

16. The method of claim 15, wherein said multiplying the first and second phasors result is:
Phasor_{A→B}*Phasor_{B→A}=e^{j(-2πf}^{₀}^{*2τ}^{_{AB}}⁾
and the resulted phase value is:
$${Φ}_{AB} = 2 π {f}_{0} * 2 {τ}_{AB} = 2 π * \frac{{d}_{AB}}{λ / 2}$$
wherein the resulted phase value depends on the distance d_{AB} modulo λ/2 between the two sensors, and where
$$λ = \frac{c}{{f}_{0}}$$
is the transmitted signal wavelength and wherein the computed phase Φ_{AB} does not depend on the arbitrary transmission phases φ_{A} and φ_{B}.

17. The method of claim 12, wherein a distance change between the two sensors of δd is identified by calculating a phase change δϕ and wherein the phase change δϕ is:
$$δ ϕ = 2 π \frac{δ d}{λ / 2}$$

18. The method of claim 12, wherein the at least one processor is configured to cancel leakage of the one or more transmitted RF signals into the signal simultaneously received at the same sensor.

19. The method of claim 18, where the leakage is cancelled by transmitting and recording at each sensor of the at least two sensors a sequence of signals, and transmitting the recorded signals to the at least one processor which processes the recorded signals to cancel the leakage.

20. The method of claim 12, wherein the time-base synchronization subsystem is selected from the group consisting of: may include GPS receivers, dedicated signaling exchange between sensors, wired common clock distribution or other known methods or systems.

21. The method of claim 12, wherein at least one sensor of said at least two sensors comprises said at least one processor.

22. The method of claim 12, wherein said at least one processor is comprised in a central processor and wherein said central processor is external to said at least two processors.

23. A system comprising a plurality of sensors, each sensor comprising:
a signal generator wherein the signal produced by the generator is used as a transmitted signal and as a local oscillator for down-converting signals received from other sensors to produce an IF (intermediate frequency) signal;
a data acquisition subsystem configured to generate data samples comprising phase information of the plurality of IF signals and record said data samples;
at least one processor, said at least one processor is configured to:
receive the recorded data samples from each sensor of said at least two sensors;
jointly process the recorded data samples from each sensor of said at least two sensors to extract a phase value which depends on the distance between the at least two sensors;
measure over time said phase value to yield a phase change value;
identify displacement of at least one sensor of the at least two sensors based on the extracted phase change value.

24. The system of claim 23, wherein said signal is selected from the group comprising:
CW signal, stepped frequency signal, chirp signal.
